(19) United States
(12) Patent Application Publication
(10) Pub. No.: US 2015/0129102 A1
(43) Pub. Date: May 14, 2015

(54) METHOD FOR COATING SOLID SUBSTRATES

(71) Applicant: CENTRE NATIONAL DE LA RECHERCHE SCIENTIFIQUE (CNRS), Paris (FR)

(72) Inventors: Daniel Samain, Meylan (FR); Camélia Stinga, Grenoble (FR)

(21) Appl. No.: 14/401,409

(22) PCT Filed: May 15, 2013
(86) PCT No.: PCT/EP2013/060043

§ 371 Date: Nov. 14, 2014

(30) Foreign Application Priority Data
May 15, 2012 (FR) 1254444

(51) Int. Cl. C09D 129/04

(52) U.S. Cl. CPC C09D 129/04
USPC 156/60; 427/340; 427/342; 524/543; 428/514

(57) ABSTRACT

A method for coating a solid substrate, which comprises coating the substrate with a coating slip comprising PVA and particles coupled to the PVA, followed by grafting of fatty acids.

The present invention pertains to methods for forming barrier films containing polyvinyl alcohol (PVA) and microparticles on the surface of solid substrates, and in particular porous solid substrates such as paper or cardboard.

Porous substrates such as cardboard or paper are known to be made occlusive by coating with a PVA layer. PVA imparts barrier properties against gases and greases but is scarcely water-repellent. The barrier properties of these PVA films can then be significantly improved by chromatografting fatty acids such as described in WO2009/083525.

We have shown that it is possible to impart greater hydrophobic properties to the surface of a solid substrate by coating the latter with a layer of polyvinyl alcohol and then causing the surface thereof to react with long chain fatty acids using a chromatografting process (EP1007202). In particular we have shown that, unexpectedly, the reaction is not limited to the surface alone of the PVA layer but that it penetrates to a slight depth to form a thin film of fully acylated PVA. The barrier films obtained have remarkable barrier properties against water, grease, gases and water vapour.

The advantage of adding nano/micro particles to a coating is widely documented and well known to the person skilled in the art (Schuman T et al., 2005, Smith H and Floyd WC, 2006). The purpose may simply be to increase the dry weight of the coating slip to facilitate application thereof, to pigment or modify the mechanical properties thereof e.g. abrasion resistance. Another advantage is to increase its barrier properties against gases and liquids through the principle of increased tortuosity (Schuman T et al., 2005, P. Duangkaew, J. Wootthikanokkhan, 2008, Chun-Chen Yang & Ying-Deng Lee, 2009).

Unfortunately we have ascertained that the adding of these micro/nanoparticles to the PVA coating slip, after chromatografting, translates as a notable drop in barrier values against liquid water. The presence of hydrophilic mineral fillers in the PVA layer leads to degraded water barrier properties. It is as if the behaviour of these particles is similar that of as many small hydrophilic wells.

The present invention proposes prior coupling of the particles to PVA by anchoring this PVA on the surface of the particles before mixing these particles with the PVA for the coating of solid substrates. After coating the substrates, the grafting of fatty acids via chromatografting, depending on cases, translates either by a return to the barrier values obtained without adding particles or to a marked improvement in these barrier values.

### SUMMARY

The subject of the invention is a method for coating a solid substrate, comprising the following steps:
a) Particles coupled to PVA are provided;
b) A coating slip is prepared comprising PVA and said PVA-coupled particles;
c) The solid substrate is coated with said coating slip;
d) At least one fatty acid having an aliphatic chain comprising at least 12 carbon atoms is grafted on the solid substrate coated with the coating slip.

In preferred embodiments, the solid substrate is a porous cellulose substrate such as paper or cardboard.

Preferably the PVA is coupled to the particles via covalent or polyelectrostatic bonds.

Preferably the particles are mineral particles selected from among montmorillonite, laponite, talc and calcium carbonate.

In a first embodiment, the particles are mineral particles coupled to cationic PVA.

In another embodiment, the particles are mineral particles coupled to anionic PVA.

In another embodiment, the particles are mineral particles coupled to PVA silicate.

Preferably, the PVA contained in the coating slip has a degree of hydrolysis higher than 80%.

Preferably, the PVA contained in the coating slip has a molecular weight (Mw) of at least 10 000 g/mol.

Preferably, the coating slip comprises at least 5% by weight of PVA and at least 1% by weight of PVA-coupled particles.

Preferably, the fatty acid is selected from among stearic acid, palmitic acid and behenic acid.

Preferably the grafting of the fatty acid is performed by heterogeneous phase esterification with an acid chloride having an aliphatic chain comprising at least 12 carbon atoms.

More preferably, the grafting of the fatty acid is performed by heterogeneous phase esterification with stearic acid chloride.

The invention also pertains to a coated solid substrate able to be obtained with the methods of the invention.

Preferably the solid substrate is paper or cardboard.

A further subject of the invention is the use of a coated solid substrate such as described above in a process to glue this solid substrate to itself or onto another solid substrate.

### DETAILED DESCRIPTION OF THE INVENTION

The subject of the invention is a method comprising the coating of a solid substrate with a coating slip comprising PVA and a particle filler, typically a mineral filler, followed by surface treatment of the coated substrate by chromatografting of fatty acids.

With this method it is possible to impart barrier properties to all types of solid substrates and in particular barrier properties against water, gases, greases and water vapour.

In particular the invention relates to a method for coating a solid substrate comprising the following steps:
a) Particles coupled to PVA are provided;
b) A coating slip is prepared comprising PVA and said PVA-couple particles;
c) The solid substrate is coated with said coating slip;
d) At least one fatty acid having an aliphatic chain comprising at least 12 carbon atoms is grafted onto the substrate coated with the coating slip.

All types of solid substrates can be coated and treated with the methods of the present invention. By “solid substrate” is meant any carrier, substrate or object able to be coated with PVA. PVA has a film-forming nature enabling it to be easily adsorbed on any type of surface.

The method is also adapted for the coating for porous solid substrates since the PVA will then play an occlusive role. The method of the invention is therefore particularly useful for coating cellulose substrates and porous cellulose substrates.

In one preferred embodiment the solid substrate is paper or cardboard such as special industrial papers, printing and writing paper, newspaper, cardboard, flexible packaging paper or paper for corrugated cardboard. According to one particularly advantageous embodiment of the invention, the substrate is a cellulose wrapping substrate such as paper for flexible packaging or flat cardboard.

When preparing coating slips to coat solid substrates such as cardboard or paper, it is conventional to add particulate fillers to these coating slips which may be formed of mineral fillers for example.

These particles included in the composition of coating slips are well known to the person skilled in the art. They may be of round or flat shape.

All types of particles can be used in the methods of the present invention. Preferably these particles have a size of between 1 nm and 100 μm, more preferably between 10 nm and 10 μm.

In one preferred embodiment, the particles are formed of mineral or organic particles: kaolin, montmorillonite, laponite, talc, natural calcium carbonate, micro-particulate or colloidal silica, pigments such as titanium dioxide, cellulose whiskers and fibres, chitosan nano- and micro-particles, crystalline or cross-linked polysaccharides (starch, dextran), particles of organic polymers such as latex.

Mineral fillers and pigments are conventionally used for coating paper or cardboard. These are the same mineral particles but in general the term pigment designates smaller particles.

In the methods of the present invention, the particles are coupled to PVA. By “PVA-coupled particles” is meant particles carrying PVA molecules anchored on their surface via strong bonds. Preferably the PVA is coupled to the particles via covalent or polyelectrostatic bonds.

To optimise barrier properties, it is preferable that the PVA coupled to the particles should have a high degree of hydrolysis.

Preferably, the PVA has a degree of hydrolysis higher than 80%, 85%, 90%, 95%, 98% and more preferably higher than 99%.

These particles coupled to PVA via strong bonds are well-known to the person skilled in the art and the methods of producing these particles are described in the literature (Liesiene J et al, 2005, Liesiene J, 2009, Maruyama Hitoshi & Okaya Takuji, 1994a, Maruyama Hitoshi & Okaya Takuji, 1994b).

By “PVA” is meant polyvinyl alcohol. It is typically obtained by radical polymerisation of vinyl acetate in methanol, followed by alcoholysis. In relation to the degree of hydrolysis, a certain amount of acetate remains attached to the polymer chain. The PVA is therefore characterized by its molecular weight and degree of hydrolysis.

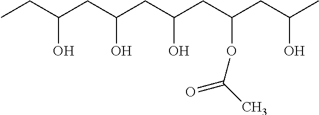 [SMILES: CCC(O)CC(O)CC(O)CC(CC(C)O)OC(C)=O]

Simplified Scheme of a PVA Molecule

Regarding the PVA coupled to the particles, its molecular weight and degree of hydrolysis are not of particular importance. The role of this PVA above all is to provide hydroxyl groups able to be esterified by fatty acids during the subsequent grafting reaction.

In a first embodiment, the particles are couple to cationic PVA via polyelectrostatic bonds. Preferably the PVA-coupled particles are mineral particles or mineral pigments coupled to cationic PVA. In preferred embodiments, they are talc particles coupled to cationic PVA, montmorillonite particles coupled to cationic PVA or laponite particles coupled to cationic PVA.

By cationic PVA is meant derivative PVA with cationic groups. These products are well known to the person skilled in the art (Moritani T & Yamauchi J, 1998a, Fatehi P, Xiao H, 2010, Liesiene J et al, 2005, Liesiene J, 2009) and are commercially available (e.g. POVAL CM 318 NY Kuraray®). They can be obtained by copolymerisation of vinyl acetate and cationic monomers followed by alcoholysis of the cationic polyvinyl acetate formed (Moritani T&Yamauchi J, 1998a) or synthesised by reaction of PVA with specific cationic reactants (Fatehi P, Xiao H, 2010, Liesiene J et al, 2005, Liesiene J, 2009) frequently used to cationize starch.

In another embodiment the particles are coupled to anionic PVA via polyelectrostatic bonds. Preferably the particles coupled to PVA are mineral particles or mineral pigments coupled to anionic PVA. In preferred embodiments, they are particles of calcium carbonate coupled to anionic PVA.

By anionic PVA is meant derivative PVA with anionic groups. These products are well known to the person skilled in the art (Moritani T & Kajitani K, 1997, Moritani T&Yamauchi J, 1998b) and are commercially available. Kuraray® offers a range of anionic (carboxylic) PVA having different degrees of hydrolysis and molecular weights. The carboxyl groups grafted on the PVA chains increase the hydrophilic nature of the PVA and therefore promote its use in applications invoving ionic interactions.

In another embodiment, the particles are coupled to PVA silicate via covalent bonds. Preferably the particles coupled to the PVA are mineral particles or mineral pigments coupled to PVA silicate. In preferred embodiments they are particles of montmorillonite coupled to PVA silicate or laponite particles coupled to PVA silicate.

By PVA silicate is meant derivative PVA with silicate groups. These products are well known to the person skilled in the art (Maruyama Hitoshi & Okaya Takuji, 1994; Maruyama Hitoshi & Okaya Takuji, 1994b) and are commercially available. Kuraray® markets PVA silicate under the name Kuraray R-Polymers (e.g. R-1130, R-3109 or R-2105), known for their capability to adhere to inorganic substrates such as glass, aluminium, steel etc. These PVA silicates are also used as binders for all types of silica routinely used as pigments in inks.

The PVA-coupled particles are mixed with PVA to obtain a coating slip. This coating slip may comprise other usual constituents of coating slips, and in particular coating slips for paper and cardboard, such as pigments, binders and additives.

Preferably the coating slip comprises at least 5%, 10%, 15% or 20% by weight of PVA and at least 1%, 5%, 10% or 15% by weight of particles coupled to PVA. Preferably the coating slip comprises between 5% and 15% by weight of PVA and between 1-10% by weight of particles coupled to PVA. More preferably, the coating slip comprises between 10%-11% by weight of PVA and between 4-5% of particles coupled to PVA. These values are evidently dependent on the size of the particles.

Regarding the PVA contained in the coating slip, the properties thereof have an impact on the final barrier properties of the coated substrate.

To optimise PVA barrier properties, it is preferable that the PVA included in the coating slip should have a high degree of hydrolysis and high molecular weight.

Preferably the PVA has a degree of hydrolysis higher than 80%, 85%, 90%, 95%, 98% and more preferably higher than 99%.

Preferably the PVA has a molecular weight (Mw) of at least 10 000, 15 000, 30 000, 50 000 or at least 75 000 g/mol.

More preferably the PVA has a molecular weight (Mw) of between 13 000 and 300 000, 30 000 and 300 000, 50 000 and 200 000, 75 000 and 200 000, 100 000 and 200 000 g/mol.

The molecular weight Mw represents the molar mass in weight and is typically determined by gel filtration chromatography using conventional techniques.

The coating of the substrate or solid substrate with the coating slip is performed using usual methods. Typically, coating is performed with an aqueous solution of PVA applying techniques well known to the person skilled in the art. Mention can be made of size presses or metering size presses, knife coaters, rod coaters, air knife coaters and curtain coaters. The coated substrate is then generally dried. Drying can be conducted for example with the single or combined use of the following: hot air oven, infrared oven, drying rollers.

At this coating step of the solid substrate with the coating slip, a layer of 1 g/m² to 30 g/m² is applied to the solid substrate. Preferably a layer of 1 to 50 g/m² is applied to the solid substrate. More preferably a layer of 5 to 15 g/m² is applied to the solid substrate.

The solid substrate coated with PVA comprising particles or pigments coupled to PVA is then grafted on the surface with fatty acids.

By grafting is meant the setting-up of covalent bonds between the PVA and the fatty acids on the surface of the PVA film, and more particularly esterification of the PVA free hydroxyl groups.

In the methods of the present invention, the grafting of the fatty acid on the solid substrate coated with coating slip is performed by esterification of the free hydroxyls of the PVA-coupled particles and by esterification of the free hydroxyls of the free PVA contained in the coating slip.

This grafting is performed using the methods described in European patent EP 1 007 202 and in international application WO2009/083525.

Grafting is typically conducted by heterogeneous phase esterification of the surface of the PVA film with the fatty acids. The surface grafting of the PVA film translates at molecular level as sequential grafting of the PVA molecules on the surface of the film. By sequential grafting is meant grafting whereby the PVA molecule is formed of alternate grafted and non-grafted segments. The grafted segments form a continuous phase of grafted PVA directed outwardly from the substrate. The non-grafted segments also form a continuous phase but directed towards the inside of the substrate.

By “fatty acid” is meant an organic acid composed of a straight hydrocarbon chain terminated at one of its ends by a carboxylic group and at the other end by a methyl group. The fatty acids used for grafting are fatty acids having an aliphatic chain comprising at least 12 carbon atoms. Preferably, the fatty acid is a fatty acid having an aliphatic chain comprising 12 to 30 carbon atoms. Preferably the fatty acid is a fatty acid having an aliphatic chain comprising 16 to 22 carbon atoms. Preferably, the fatty acid is a saturated fatty acid. In one preferred embodiment of the invention the fatty acid is selected from among stearic acid, palmitic acid and behenic acid. Preferably grafting is performed with stearic acid.

Typically the grafting of the fatty acid on the PVA film is performed by heterogeneous phase esterification. Since grafting is performed in heterogeneous phase only the OHs accessible on the surface of the PVA film are grafted with a fatty acid. Grafting does not concern the entire thickness of the film. However the advance of the grafting front allows the reagent to enter into the thickness of the substrate since it solubilises in the surface acylated polyvinyl alcohol phase created by the reaction of the acid chloride with the surface PVA.

Advantageously, grafting is performed using an activated fatty acid to obtain satisfactory grafting on the hydroxyl groups of the PVA film within a relatively short grafting time. The activated fatty acid is a fatty acid chloride for example.

Grafting is performed using techniques well known to the person skilled in the art, for example under conditions of aprotic solvents such as toluene or petroleum ether in the presence of a reagent of acid chloride type and a catalyst of pyridine type. Grafting can also be performed using chromatografting chemical techniques (EP1007202). This technique also uses reagents of acid chloride type but in the absence of solvent and catalyst during the grafting phase.

A further subject of the invention concerns coated solid substrates able to be obtained with the above-described methods. In preferred embodiments, the coated substrate is a paper or cardboard.

A further subject of the invention concerns means for gluing the PVA-coated materials after undergoing chromatografting treatment. It is extremely difficult to glue these materials since the PVA layer grafted with fatty acids has a surface that is scarcely adhesive. Conventional treatment by activation of the surface using the Coronna process does not provide a solution to this problem. We have found that grafted PVA films containing decorated particles, after activation of the surface by surface burning causes a considerable decrease in their surface energy and that their subsequent gluing together with conventional glues becomes possible.

### FIGURES

FIG. 1: Anchoring of the PVA chains to the surface of the micro/nanoparticles

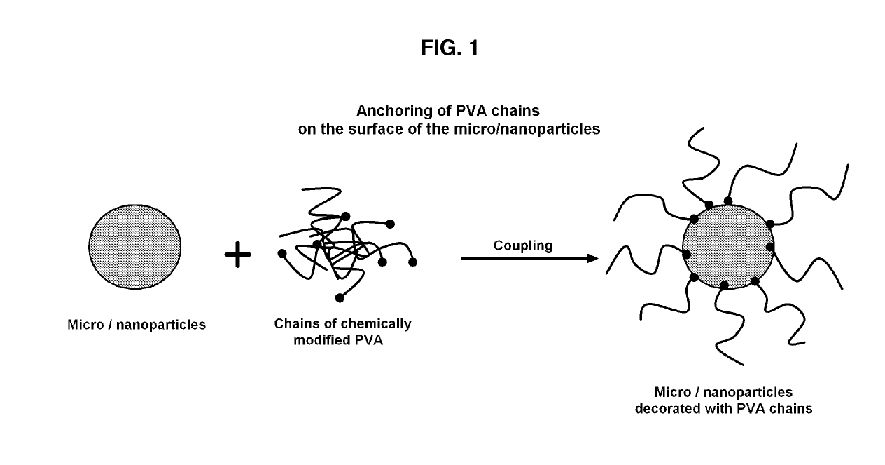

FIG. 2: Acylation of the PVA chains anchored to the surface of the micro/nanoparticles

FIG. 3: Comparison of PVA layers enclosing or not enclosing particles

### EXAMPLES

### Example 1

### Chromatografting of a Layer of Mowiol 28 99 Containing a Dispersion of Montmorillonite Particles Coated with PVA Silicate

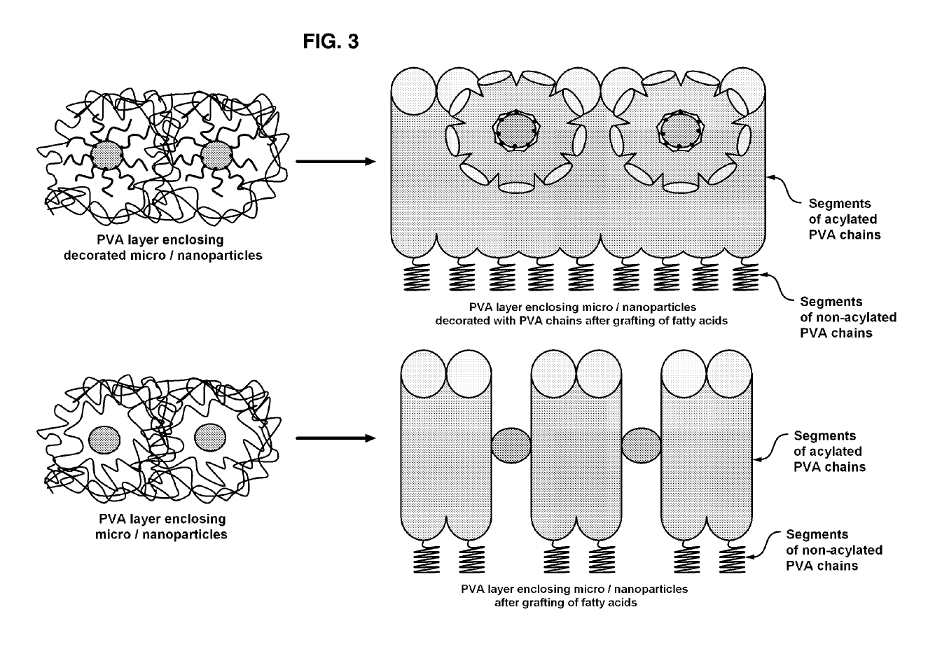

A 500 ml flask containing 200 ml of deionised water was charged with 1.5 g of montmorillonite particles (Cloisite Na⁺, Rockwood) and 4.5 g of PVA Silicate (R1130 by Kuraray). The suspension was brought to 80-90° C. then left under agitation for 1 to 2 hours until complete dissolution of the PVA Silicate. The pH of the solution at this stage was 7-8. It was adjusted to 3-4 by adding 1 ml of acetic acid. After ½ h agitation the dispersion was decanted and the excess PVA Silicate removed. The decorated particles were re-dispersed in 281.5 g of deionised water. The addition was then made of 28.5 g of PVA (Mowiol 2899), and the system was again left under agitation for a further 1 to 2 hours at 80-90° C. The coating slip obtained was used to obtain a coating of 8 g/m² on sheets of paper using an Elcometer. After drying, the coated papers were subjected to chromatografting by transfer method. One sheet of paper called the emitter was loaded with reagent by impregnating with a 2% solution of stearic acid chloride in petroleum ether 100-140. After complete evaporation of the solvent, this sheet was placed in contact with the substrate sheet and the sandwich thus formed was placed for 10 min in an oven heated to 150° C. under slightly reduced pressure (900 mbar) and in a stream of nitrogen. These conditions allowed the diffusion of the reagent of the emitter towards the substrate. The substrate sheet was then separated from the emitter sheet and analysed. After grafting, the sheets of paper were conditioned at 105° C. for 24 h. Reference samples were formed by directly dispersing native Montmorillonite particles in Mowiol 2899 under the same conditions of concentration or by omitting the particles. The water barrier properties of the coated papers were measured using the Cobb 1800 method (ISO standard 535, 1991). The results obtained indicate a value of 5 g/m2 (standard deviation 0.3 g/m2)) for the reference without particles and 11.6 g/m2 (standard deviation 1.6 g/m2) for the reference containing native particles. These results therefore indicate a distinct degradation in barrier properties further to the addition of the particles to the coating slip. The particles behave as hydrophilic wells (FIG. 3). On the other hand, the results obtained with the particles coated with PVA Silicate indicate a value of 5.1 g/m2 (standard deviation 1.2 g/m2), similar to that obtained with pure Mowiol. The presence of PVA chains around the particles therefore allowed the elimination of the degradation phenomenon of barrier properties related to the use of these particles. The Montmorillonite particles decorated with PVA Silicate behave as if they were entirely composed of PVA (FIG. 3).

### Example 2

### Chromatografting of a Layer of Mowiol 28 99 Containing a Dispersion of Laponite Particles Coated with PVA Silicate

The same protocol was followed as described in Example 1 replacing the montmorillonite with laponite (Rockwood). The results obtained this time indicate a water absorption value of 9.2 g/m2 (standard deviation 0.6 g/m2) for the PVA layer containing native laponite and only 3.7 g/m2 (standard deviation 0.7 g/m2) for the laponite coated with PVA Silicate. A distinct improvement is found in the barrier properties after implementation of the invention.

### Example 3

### Preparation of a Suspension of Talc Particles Coated with Cationic PVA in a Solution of Neutral PVA

The same protocol was followed as the one described in Example 1 but replacing montmorillonite with talc (Steaplus HAR, Imerys) and PVASi with Cationic PVA (POVAL CM 318, Kuraray) and by omitting the step to add acetic acid. The results obtained indicate a water absorption value of 4.1 g/m2 (standard deviation 0.5 g/m2) for the PVA layer containing native talc and 2.7 g/m2 (1.1) for the talc coated with cationic PVA. These results indicate that the particles of native talc already lead to lesser degradation of barrier properties than the montmorillonite and laponite particles, but in addition that the coating with chains of cationic PVA leads to a particularly marked improvement in barrier properties thereby demonstrating the advantage of the invention.

### Example 4

### Chromatografting of a Layer of Mowiol 28 99 Containing a Dispersion of Montmorillonite Particles Coated with Cationic PVA

The same protocol was followed as the one described in Example 3 replacing the talc with montmorillonite. The results obtained indicate a water absorption value of 7.0 g/m2 (standard deviation 1.5 g/m2) for the layer containing montmorillonite coated with cationic PVA. These results indicate that for montmorillonite the use of cationic PVA leads to water barrier properties inferior to those obtained when using PVASi, which demonstrates that the quality of the coating of the montmorillonite particles with cationic PVA is not as good compared with PVA Silicate.

### Example 5

### Chromatografting of a Layer of Mowiol 28 99 Containing a Dispersion of Laponite Particles Coated with Cationic PVA

The same protocol was followed as the one described in Example 3 replacing the talc with laponite. The results obtained indicate a water absorption value of 4.5 g/m2 (standard deviation 0.5 g/m2) for the layer containing laponite coated with cationic PVA. These results indicate that for laponite the use of cationic PVA leads to water barrier properties lower than those obtained with PVA Silicate, this demonstrating that the quality of the coating of laponite particles with cationic PVA is inferior to that obtained with PVASi. The comparison of the results obtained with those obtained for montmorillonite indicates the existence of specificity related to the nature of the particles themselves.

### Example 6

### Chromatografting of a Layer of Mowiol 28 99 Containing a Dispersion of Calcium Carbonate Particles Coated with Anionic PVA

The same protocol was followed as the one described in Example 3 replacing the talc with calcium carbonate (Carbital 110, Imerys) and cationic PVA with anionic PVA (KL 318 by Kuraray). The results obtained indicate a water absorption value of 10.5 g/m2 (standard deviation 0.7 g/m2) for the layer containing native carbonate and 4.6 g/m2 (standard deviation 0.6 g/m2) for the layer containing carbonate coated with anionic PVA. These results indicate that it is possible to obtain good barrier properties by adapting PVA type to the chemical nature of the particles.

### Example 7

### IR-ATR Analysis

IR-ATR Spectra of Coated and Grafted Paper

IR analysis in ATR mode was performed on the coated papers before and after chromatografting. The results obtained confirm the results obtained on water barrier properties.

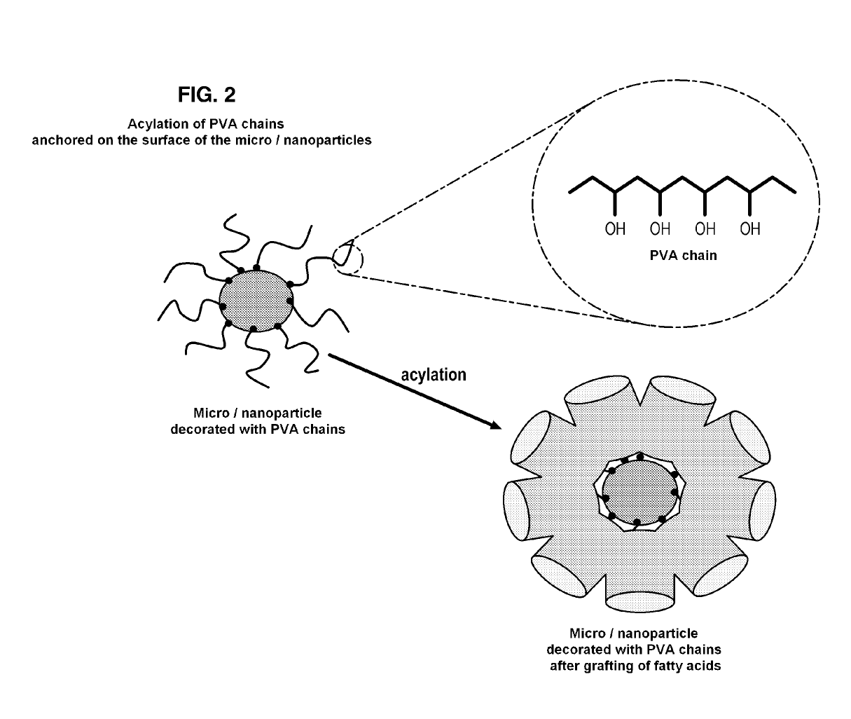

The results given in FIG. 2 indicate that the spectrum of the grafted Mowiol 28 99 layer containing particles of native Montmorillonite shows a relatively large residual band at 3306 cm⁻¹. This band is characteristic of the OH functions. This result therefore tallies with the degradation of water barrier properties observed with native montmorillonite and which we had interpreted as resulting from the presence of hydrophilic wells. On the other hand, the spectrum obtained with decorated montmorillonite shows a much smaller band, comparable with the band obtained with pure Mowiol, which tallies with the barrier levels which are similar. Also, the OH band observed with the particles coated with cationic PVA appears larger than the band observed with pure PVA which again tallies with lesser barrier properties.

The results given in FIG. 3 are even more distinct. They indicate a very large residual OH band for the layer containing carbonate not coated with anionic PVA, and a much reduced OH band for the layer containing carbonate coated with anionic PVA.

### Example 8

### Gluing of Papers Coated with Grafted PVA Containing Talc Particles Associated with Cationic PVA

A sheet of paper coated with PVA containing talc particles associated via electrolytic bonding with cationic PVA obtained in Example 3 was locally subjected to oxidizing treatment by mere surface burning. The angle of contact was measured before and after burning. The value dropped from 108° to below 10°. The sheet was then glued together using ordinary amylaceous glue.

### REFERENCES

### Patent References

EP 1007202

WO 2009/083525

U.S. Pat. No. 7,144,946

### BIBLIOGRAPHIC REFERENCES

1. Chun-Chen Yang & Ying-Jeng Lee, “Preparation of the acidic PVA/MMT nanocomposite polymer membrane for the direct methanol fuel cell (DMFC)”, Thin Solid Films 517, p. 4735-4740, (2009)
2. Duangkaew P., Wootthikanokkhan J., “Methanol Permeability and Proton Conductivity of Direct Methanol Fuel Cell Membranes Based on Sulfonated Poly(vinyl alcohol)-Layered Silicate Nanocomposites”, Journal of Applied Polymer Science, Vol. 109, p. 452-458 (2008)
3. Fatehi P, Xiao H, “Effect of cationic PVA characteristics on fiber and paper properties at saturation level of polymer adsorption”, Carbohydrate Polymers 79, p. 423-428, 2010
4. Liesiene J et al, “Sorption of poly(vinyl alcohol) and its cationic derivative on silica oxide: effect of charge”, Chemical Technology 2 (36)-ISSN 1392-1231-p. 51-56, 2005.
5. Liesiene Jolanta, “Coating of Silica Surface with Poly(vinyl alcohol): Effect of the Surface Charge”, 2009-poster
6. Maruyama Hitoshi & Okaya Takuji, “Study on the interaction between poly(vinyl alcohol) containing silanol groups at side chains and inorganic substances” Nippon Kagaku Kaishi (4), p. 365-70, 1994a
7. Maruyama Hitoshi & Okaya Takuji, “Study on the composites of colloidal silica and poly(vinyl alcohol) modified with a small amount of silanol groups”, Nippon Kagaku Kaishi (5), p. 450-5, 1994b
8. Moritani T & Kajitani K, “Functional modification of poly(vinyl alcohol) by copolymerization: 1. Modification with carboxylic monomers”, Polymer Vol. 38 No. 12, p. 2933-2945, 1997
9. Moritani T & Yamauchi J, “Functional modification of poly(vinyl alcohol) by copolymerization III. Modification with cationic monomers”, Polymer Vol. 39 No. 3, p. 559-572, 1998a
10. Moritani T & Yamauchi J, “Functional modification of poly(vinyl alcohol) by copolymerization: II. Modification with a sulfonate monomer”, Polymer Vol. 39 No. 3, p. 553-557, 1998b
11. Schuman T et al., “Characteristics of pigment-filled polymer coatings on paperboard”, Progress in Organic Coatings 54, p. 360-371, (2005).

1. A method for coating a solid substrate comprising the following steps:
a) Particles coupled to PVA are provided;
b) A coating slip is prepared comprising PVA and said PVA-coupled particles;
c) The solid substrate is coated with said coating slip;
d) At least one fatty acid having an aliphatic chain comprising at least 12 carbon atoms is grafted on the solid substrate coated with the coating slip.

2. The method for coating a solid substrate according to claim 1 wherein the solid substrate is a porous cellulose substrate such as paper and cardboard.

3. The method for coating a solid substrate according to claim 1 wherein the PVA is coupled to the particles via covalent or polyelectrostatic bonds.

4. The method for coating a solid substrate according to claim 1 wherein the particles are mineral particles selected from among montmorillonite, laponite, talc and calcium carbonate.

5. The method for coating a solid substrate according to one claim 1 wherein the particles are mineral particles coupled to cationic PVA.

6. The method for coating a solid substrate according to claim 1 wherein the particles are mineral particles coupled to anionic PVA.

7. The method for coating a solid substrate according to claim 1 wherein the particles are mineral particles coupled to PVA silicate.

8. The method for coating a solid substrate according to claim 1 wherein the PVA contained in the coating slip has a degree of hydrolysis higher than 80%.

9. The method for coating a solid substrate according to claim 1 wherein the PVA contained in the coating slip has a molecular weight (Mw) of at least 10 000 g/mol.

10. The method for coating a solid substrate according to claim 1 wherein the coating slip comprises at least 5% by weight of PVA and at least 1% by weight of PVA-coupled particles.

11. The method for coating a solid substrate according to claim 1 wherein the fatty acid is selected from among stearic acid, palmitic acid and behenic acid.

12. The method for coating a solid substrate according to claim 1 wherein the grafting of the fatty acid is performed by heterogeneous phase esterification with an acid chloride having an aliphatic chain comprising at least 12 carbon atoms.

13. The method for coating a solid substrate according to claim 1 wherein the grafting of the fatty acid is performed by heterogeneous phase esterification with stearic acid chloride.

14. A coated solid substrate able to be obtained using the method according to claim 1.

15. The coated solid substrate according to claim 14 wherein the solid substrate is paper or cardboard.

16. The use of a coated solid substrate according to claim 14 in a process to glue said solid substrate to itself or onto another solid substrate.
